(19) United States
(12) Patent Application Publication
(10) Pub. No.: US 2021/0276351 A1
(43) Pub. Date: Sep. 9, 2021

(54) COVERS

(71) Applicant: Hewlett-Packard Development Company, L.P., Spring, TX (US)

(72) Inventors: Swee Siang Lim, Singapore (SG); Shiok Lin Jasmine Tay, Singapore (SG)

(73) Assignee: Hewlett-Packard Development Company, L.P., Spring, TX (US)

(21) Appl. No.: 17/260,092

(22) PCT Filed: Sep. 21, 2018
(86) PCT No.: PCT/US2018/052149

§ 371 Date: Jan. 13, 2021

(51) Int. Cl. B41J 29/13; B41J 29/02

(52) U.S. Cl. CPC B41J 29/13; B41J 29/02

(57) ABSTRACT

A print device comprising a plurality of outer surfaces, a media egress, and a cover. The media egress is arranged in an outer surface of the plurality of outer surfaces. And the cover is moveable between a first state and a second state, wherein in the second state the cover to obscure the outer surface in which the media egress is arranged.

### BACKGROUND

Some print devices may form markings on media. Some other print devices may form objects using additive processes and build materials. Print devices may have utilitarian design and aesthetic.

### BRIEF DESCRIPTION OF THE DRAWINGS

Various examples will be described below by referring to the following figures,

FIGS. 1A and 18 are illustrations of an example multi-functional cover accessory in a plurality of states with respect to an example print device;

FIG. 1C is an illustration of an example print device;

FIG. 2 is an illustration of an example print device and an example cover;

FIG. 3 is an illustration of an example cover;

FIGS. 4A-4C are illustrations of operation of an example attachment mechanism;

FIG. 5 is an illustration of an example attachment mechanism of an example cover and an example print device;

FIG. 6 is an illustration of another example attachment mechanism of an example cover and an example print device;

FIG. 7 is a perspective view of the example cover of FIG. 6; and

FIGS. 8A, 8B, 9, 10A, and 10B are illustrations of an example media stops.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

Print devices for forming text and images on a substrate (e.g., two-dimensional (2D) print devices) and print devices for forming three-dimensional (3D) objects, such as through additive processes (collectively, “print devices”), may not be accessed regularly for a number of possible reasons. One example son for not regularly printing may include a reliance on a wired connection to client device, such as a personal computer or workstation. Users may view the process of sitting down at a client device or connecting and disconnecting a print device from a client device as onerous. Further, such a connection may further increase the likelihood that print devices remain outside of living spaces and/or otherwise hidden from view, such as in an office, behind cabinet doors, in closets, etc.

Advances in technology have enabled print devices that may operate without a physical (e.g., wired) connection to client devices. For example, using wireless technology, print jobs may be transmitted to print devices from remote locations, either on a same network as the print device, or on an external network. In some cases, for example, print devices may have a connection to a wide-area network (WAN), such as the Internet, to enable reception of print jobs from a number of devices at a number of different locations.

Additionally, print devices may tend to be large, bulky, unwieldy, utilitarian in form and appearance, etc. Consequently, rather than keeping print devices in living spaces, it may be more likely that print devices be placed in offices, placed behind closed doors, and/or generally hidden from view. As such, the print devices may be used less frequently than if they were in prominent lotions within, living space. Additionally, some users may decide to forgo purchase of a print device altogether merely based on not liking print device form or appearance.

Though there have been advances in improving the design aesthetic of print devices and/or to reduce a size thereof, there may remain a resistance to purchasing and/or placing print devices in living spaces, such as on shelves, end tables, etc., of a living room, by way of illustration.

There may be a desire, therefore, for a mechanism to increase a likelihood that print devices be placed in visible locations. One approach to overcoming the foregoing challenges includes the use of a multi-functional cover accessory, such as a printer cover having materials with desirable characteristics (e.g., leather materials, woodgrain, fabrics, cork, etc.) that may be sufficient to render the print device more aesthetically pleasing to users. However, the multi-functional cover accessory should be such as to not interfere with the operation of the print device (e.g., hinder media output). Therefore, as used herein, this multifunctional cover accessory is referred to as a “cover” or a “printer cover,” and refers to an accessory to cover outer surfaces of print devices.

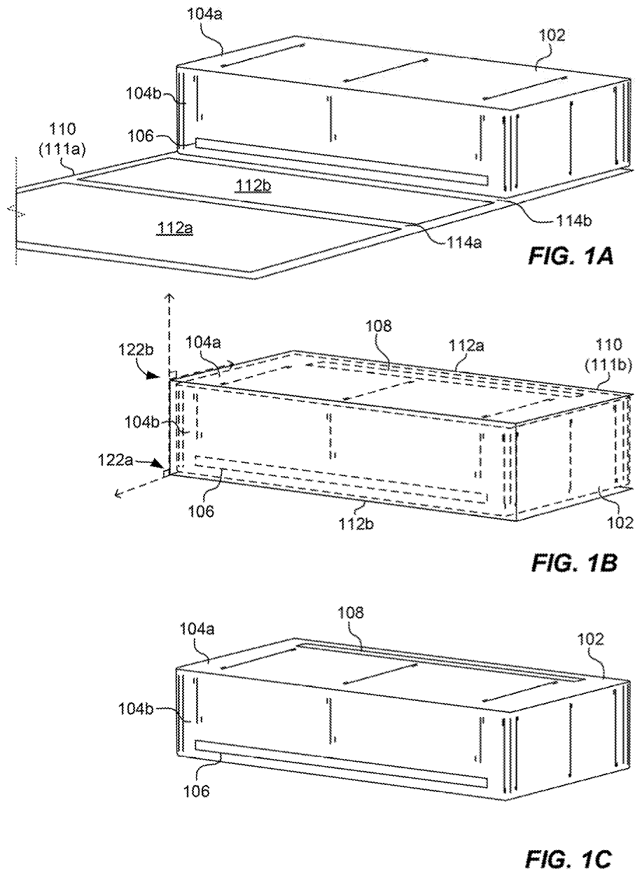

FIG. 1A illustrates an example cover 110 in a first state 111a, which corresponds to an open or operational state in this example, and FIG. 1B illustrates an example cover 110 in a second state 111b, which corresponds to a closed or non-operational state in this example. FIG. 1B shows print device 102 with broken lines to not obscure features of cover 110. FIG. 1C illustrates print device 102 without a cover, such as cover 110 shown in FIGS. 1A and 1B.

Example print device 102 may have a plurality of outer surfaces, such as example outer surfaces 104a and 104b. An example media egress 106 is shown in outer surface 104b to illustrate an opening through which media may be output after impression. As noted, there may be a desire for cover 110 to obscure portions of print device 102, such as outer surfaces 104a and 104b and media egress 106.

Cover 110 may have a first portion 112a and a second portion 112b, which may be rigid or solid in nature, connected by articulating portions 114a and 114b. First portion 112a and second portion 112b may comprise a rigid substrate (e.g., comprising a cardboard, plastic, or other like material) surrounded by a flexible material, such as a fabric. Other example external materials may include polyester woven fabric, suede (and variations thereof), and cork, without limitation. Articulating portions, such as articulating portions 114a and 114b, may be made up of a mechanism to allow solid portions of cover 110 to move with respect to each other. For instance, hinges or a flexible material may be used to connect rigid portions of cover 110. In one example, articulating portions 114a and 114b may be formed by the material that makes up the outer surface of cover 110 and an absence of a rigid core.

Thus, in operation, articulating portions 114a and 114b may allow cover 110 to transition between a first state 111a and a second state 111b. For example, in a first state 111a, articulating portions 114a and 114b may allow first and second portions 112a and 112b to lay open, such as in front of outer surface 104b and media egress 106. As such, in the first state 111a, cover 110 may function as a media tray to receive print media. Similarly, articulating portions 114a and 114b may, in a second state, avow first and second portions 112a and 112b to fold to obscure outer surfaces 104a and 104b and media egress 106, which may correspond to a storage or n -operational state. Therefore, cover 110 may be moveable between a first state 111a and a second state 111b such that in the second state, cover 114 obscures outer surface 104b in which media egress 106 is arranged.

While in a second state 111b, as illustrated in FIG. 18, cover 110 may be arranged such that first and second portions 112a and 112b are arranged at an approximately perpendicular angle with respect to each other, as shown by angle 122b. Further, an additional portion of cover 110, obscured under print device 102 in FIGS. 1A and 1B, may also be arranged at an approximately perpendicular angle with respect to second portion 112b, as shown by angle 122a.

In some cases, print device 102 may also include a media ingress 108, as shown in FIGS. 1B and IC, which also may be obscured by cover 110 while in second state 111b.

An additional aspect of a cover, like cover 110 discussed in relation to FIGS. 1A and 1B, is the ability to attach and detach the cover to and from a print device. For example, there may be an interest in being able to attach and detach the cover, such as to allow users to change covers, use the print device without a cover, etc.

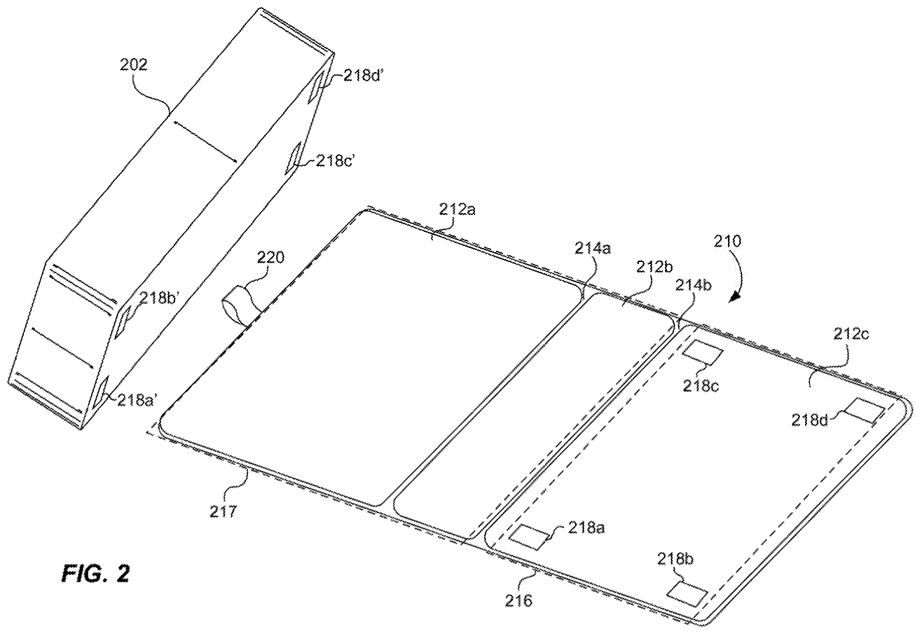

FIG. 2 illustrates a cover 210 as detached from print device 202. Cover 210 may be similar to cover 110, discussed above, and print device 202 may be similar to print device 102, also discussed above.

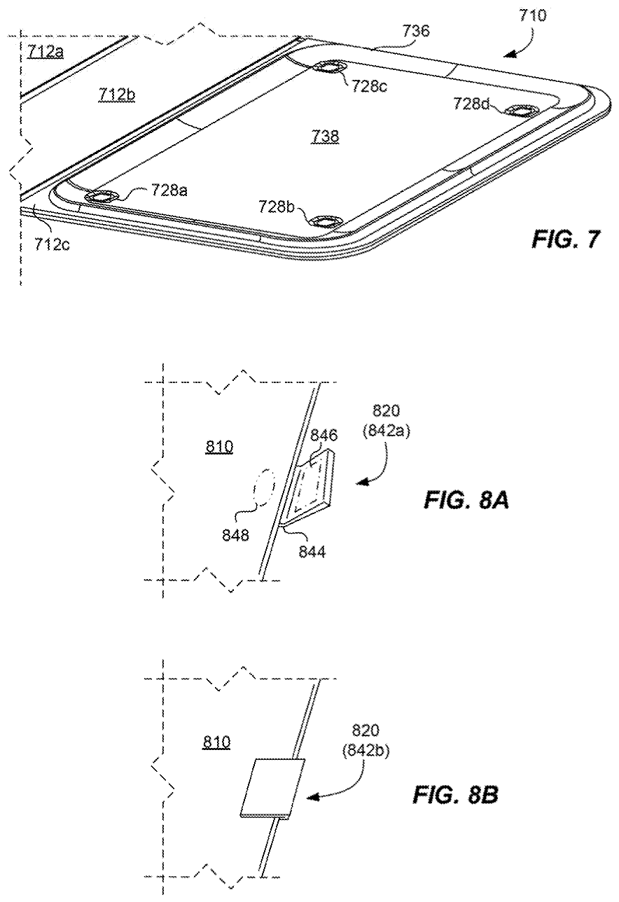

Cover 210 may have an attachment portion 216 (called out using a dotted rectangle) and a multi-functional portion 217 (also referred to as an obscuring portion, such as due to its ability to obscure portions of print device 202). Attachment portion 216 may comprise a solid portion 212c, which may be similar to solid portions 212a and 212b. In one implementation, attachment portion 216 may have attachment mechanisms 218a-218d, which may enable attachment of print device 202 arid cover 210. In other implementations, rather than having multiple attachment mechanisms 218a-218d, a single attachment mechanism may be used. One such implementation will be described in greater detail hereinafter in relation to FIGS. 6 and 7.

Returning to FIG. 2, attachment mechanisms 218a-218d are illustrated in proximity to corners of solid portion 212c of attachment portion 216. It is noted that the placement of attachment mechanisms 218a-218d is to enable a connection between attachment mechanisms 218a-218d and corresponding attachment mechanisms 218a′-218d′ on print device 202. Of coarse, other arrangements of attachment mechanisms on cover 210 and print device 202 are contemplated by the present description.

Similar to as is discussed above for cover 110, in relation to FIGS. 1A and 1B, cover 210 may comprise a plurality of solid portions 212a-212c connected via articulating portions 214a and 214b. For instance, as illustrated, a first solid portion 212a may be connected to a second solid portion 212b via a first articulating portion 214a. And second solid portion 212b may be connected to third solid portion 212c via a second articulating portion 214b. In one example, articulating portions 214a and 214b may comprise a material such as a fabric, which surrounds solid portions 212a-212c (e.g., comprising rigid or solid substrates, such as comprising a plastic meter

Solid portions 212a-212c of cover 110 may comprise separate solid cores or substrates (e.g., a molded substrate), such as comprising a plastic material. Example materials to form the substrates of solid portions 212a-212c may include polycarbonate (PC), polyester, polypropylene, polyethylene, and acrylics, without limitation.

FIG. 2 also shows a media stop 220 arranged to retain media that exits a media egress, such as media egress 106 in FIG. 1, on top of multi-functional portion 217 of cover 210. Media stop 220 may take a number of different forms, as will be discussed hereinafter in conjunction with FIGS. 8A, 8B, 9, 10A. and 10B, which illustrate several example media stop implementations. The present description also refers to media stops as media stop tabs and media stop components.

With the foregoing in mind, therefore, an example attachable printer cover (e.,g., cover 210) may include an attachment portion (e.g., attachment portion 216) and an obscuring portion (e.g., obscuring portion 217). The attachment portion may include an attachment mechanism (e.g., attachment mechanism 218a) arranged to correspond to a portion of a print device (e.g., attachment mechanism 218a′ on print device 202). The obscuring portion may include an articulation (e.g., first articulating portion 214a) dividing the obscuring portion into two subportions (e.g., first solid portion 212a and second solid portion 212b). The first subportion of the two subportions may be such as to cover a first exterior surface of the print device. And a second subportion of the two subportions may be such as to cover a second exterior surface of the print device. Also, the printer cover may include a media stop (e.g., media stop 220).

In one implementation, the attachment portion of the printer cover may have a plurality of attachment mechanisms (e.g., attachment mechanisms 218a-218d d) corresponding to attachment mechanisms (e.g., attachment mechanisms 218a′-218d′) of a print device.

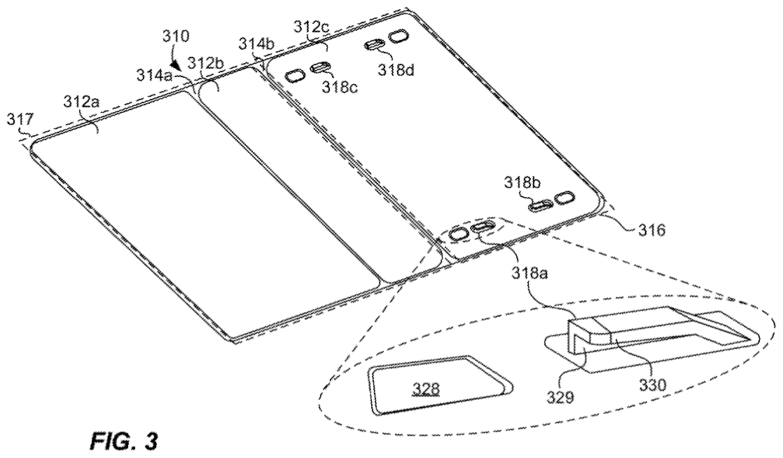

As noted, there may be a desire to attach and detach a print device, such as print device 202, to and from a cover, such as cover 210, using attachment mechanisms. FIG. 3 illustrates an implementation in which four attachment mechanisms 318a-318d are used to attach cover 310 to a print device, such as print device 102 or print device 202. Cover 310 may be similar to covers 110 and 210, discussed above, such as comprising a multi-functional portion 317, an attachment portion 316, solid portions 312a-312c, and articulating portions 314a and 314b. As illustrated, attachment mechanisms 318a-313d may be arranged near corners of a sad portion, in this case, third solid portion 312c, of cover 310. Attachment mechanisms 318a-318d may be arranged to correspond to placement of corresponding attachment mechanisms on a print device (e.g., attachment mechanisms 218a′-218d′ of print device 202, discussed above). It is to be understood that the particular arrangement of attachment mechanisms illustrated in FIG. 3 is merely for illustration and is not to be taken in a limiting sense.

A number of possible attachment mechanisms y be used, including, without limitation, magnetic and physical mating (e g., latching) attachment mechanisms. FIG. 3 illustrates an implementation in which attachment mechanisms 318a-318d are latching and sliding mechanisms that use a physical connection between a latch and receptacle to attach cover 310 to a print device

To illustrate, FIG. 3 includes a detailed zoomed view of example attachment mechanism 318a. Example attachment mechanism 318a may be referred to as a sliding mechanism and corresponding attachment mechanisms on the print device may be referred to as a reception mechanism and may comprise an opening and a groove to receive the sliding mechanism. For instance, as shown, attachment mechanism 318a may include a raised portion 329 and an engaging portion 330. The raised portion 329 and the engaging portion 330 may interact with corresponding reception mechanisms of the print device to create a physical attachment between the cover and the print device. For instance, raised portion 329 may be movable within a slot in a corresponding attachment mechanism. While engaging portion 330 may fit within a groove defined by a lower rail and an upper surface of a corresponding attachment mechanism (and may act to secure cover 310 to the print device). The particular physical structures of example attachment mechanism 318a and the corresponding attachment mechanism of the print device will be discussed in relation to FIGS, 4A-4C.

Cover 310 also includes indentations, such as example indentation 328, that may correspond to physical structures (e.g., feet) on the bottom of a print device. As noted above, a solid core of a portion of cover 310, such as third portion 312c, may comprise a molded substrate. In one such case, a molded plastic substrate may include contours that correspond to contours of a portion of a print device. Using the example of feet on the bottom of the print device, the molded substrate may have indentations that correspond to the feet, It is to be understood, however, that the molded substrate, may also contour to other aspects of the, physical structure of the print device, including curves around the perimeter of a bottom portion, as shall be discussed in greater detail hereinafter in relation to FIGS. 6 and 7.

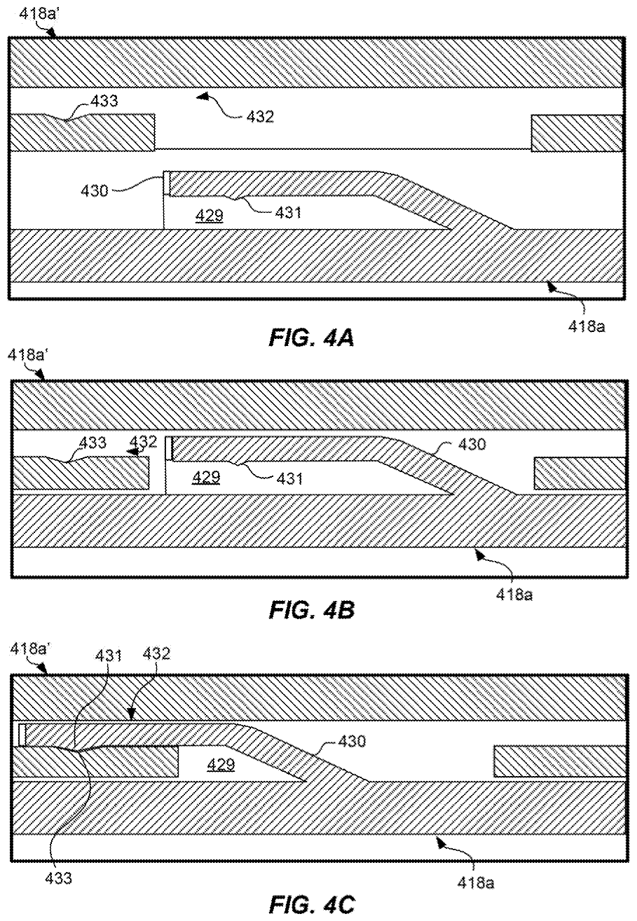

FIGS, 4A-4C illustrate how attachment between a cover and a print device may occur using the example attachment mechanism 318a in FIG. 3. In FIGS. 4A-4C a cross-sectional drawing of example attachment mechanism 418a is shown. Attachment mechanism 418a corresponds to a corresponding attachment mechanism 418a′ (e.g., a reception mechanisms) of a print device (e.g., print device 202), which is shown as the upper component in the cross-sectional drawings of FIGS. 4A-4C.

Attachment mechanic m 418a may include a raised 429 and an engaging portion 430, similar to raised portion 329 and engaging portion 330, described in relation to FIG. 3. Raised portion 429 and engaging portion 430 may be so as to enter a receptacle 432 of print device attachment mechanism 41 as In order to facilitate attachment, a portion of engaging portion 430 may be approximately parallel to a lower structure of corresponding attachment mechanism 418a′, as shown below receptacle 432. Engagement of engaging portion 430 between these two structures may lead to attachment of the two attachment mechanisms. Further, engaging portion 430 may include a latch 431 to engage within a notch 433 of receptacle 432. Latch 431 and notch 433 may be such as to cause an initial resistance during detachment of attachment mechanism 418a and corresponding attachment mechanism 418a′ of the print device. Thus, in one example, attachment mechanism 418a and corresponding attachment mechanism 418a′ of the print device may be referred to as a sliding and latching attachment mechanism.

Turning now to FIGS. 4A-4C to illustrate one example attachment method, in FIG. 4A attachment mechanism 418a and corresponding attachment mechanism 418a′ of a print device are initially detached. To attach a cover to a print device, attachment mechanism 418a is to be arranged with respect to an opening of a corresponding attachment mechanism 418a′ of a print device such that engaging portion 430 may be inserted therein.

FIG. 4B illustrates attachment mechanism 418a within a corresponding attachment mechanism 418a′ of a print device, Once in position, engaging portion 430 may be caused to move within receptacle 432 (e.g., such as by sliding the components with respect to each other),

FIG. 4C illustrates attachment mechanism 418a fully within (and engaged with respect to) corresponding attachment mechanism 418a′. As shown, latch 431 of engaging portion 430 has engaged with notch 433 of corresponding attachment mechanism 418a′.

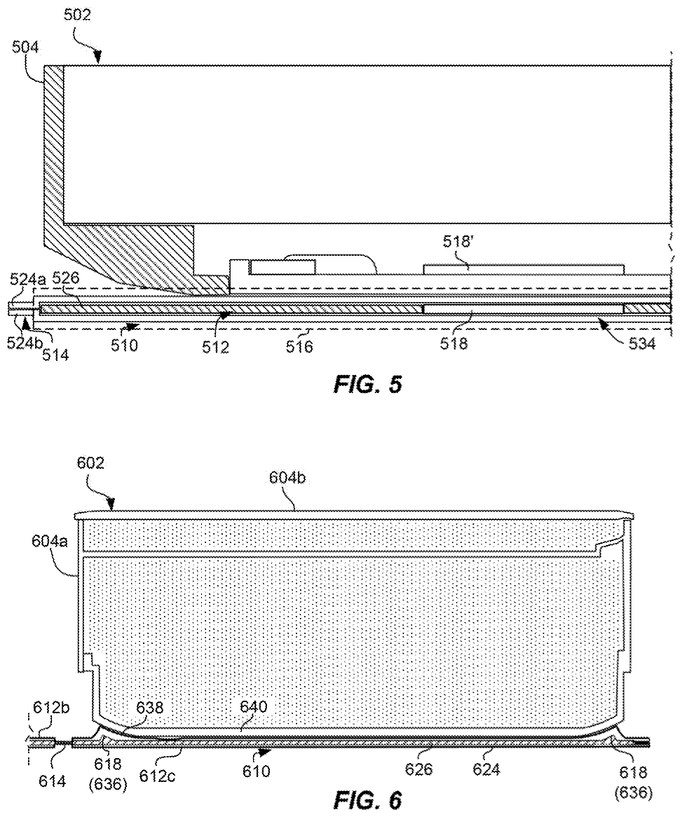

FIG. 5 illustrates another possible attachment implementation in which attachment mechanism 518 of cover 510 and corresponding attachment mechanism 518′ of print device 502 attach due to action of an electromagnetic force acting therebetween. This implementation is illustrated using a cross-sectional view of a subpart of attachment portion 516 (shown with a dotted line) that encompasses a rigid portion 512 of cover 510. In one case, attachment mechanism 518 may comprise a magnet and corresponding attachment mechanism 518′ may, comprise a magnetically reactive material (e.g., a metal or metal alloy). Such magnetic attachment mechanisms may be referred to as magnetic connectors.

In one implementation of using magnetic connectors s attachment mechanisms, attachment mechanism 518 may be arranged between layers of upper covering material 524a and lower covering material 524b. And the corresponding attachment mechanism 518′ of print device 502 may be arranged underneath an outer surface, such as outer surface 504, of print device 502, to correspond to attachment mechanism 518. The cross section of a cover 510 in FIG. 5 also illustrates a rigid core or molded substrate 526, of portion 512. Attachment mechanism 518 may be arranged within gaps (e.g., gap 534) in molded substrate 526, as shown, FIG. 5 also illustrates a cross-sectional view of an example articulating portion 514, As should be apparent, in one implementation, articulating portions, such as articulating portion 514, may be made up of exterior materials without a rigid core.

It is noted that in one implementation, a single magnetic connector may be used, while in another implementation, more than one magnetic connectors may be used (e.g., arranged similarly to attachment mechanisms 318a-318d), without limitation.

As noted above, a printer cover may include a molded substrate that may contour to portions of a print device. FIG. 6 illustrates an implementation in which an attachment mechanism 618 of a cover 610 may include a molded substrate 626 (e.g., surrounded by a covering material 624) includes a raised portion 636, which surrounds (and contours to) a base portion 640 of print device 602. For instance, raised portion 636 may have a lower inner portion,638 that, may be usable to restrain lateral movement of print device 602 (e.g., movement approximately parallel to a plane of cover 610), such as due to contact between inner lower portion 638 and base portion 640 of print device 602. Said otherwise, raised portion 636 may have a lower inner portion 638 that may define contours of a print device, such as print device 602. Raised portion 636 and lower inner portion 638 may correspond to a form of base portion 640 of print device 602, Consequently, print device 602 may be received within a space defined by raised portion 636 and lower inner portion 638.

The contoured raised portion 636 may be arranged in third portion 612c of cover 610. Third portion 612c may be connected to second portion 612b via articulating portion 614. And print device 602 may have a media egress arranged on outer surface 604a, similar to media egress 106, discussed above in relation to FIGS. 1A-1C. Therefore, consistent with the above description, cover 610 may be able to change to a state (e.g., a non-operational state) in which second portion 612b is raised to obscure outer surface 604a, and a first portion (not shown in

FIG. 6 due to space constraints, but similar to first portion 112a of FIG. 1A) may be raised to obscure outer surface 604b (e.g., which may comprise a media ingress in some cases).

To further illustrate a possible implementation of an attachment mechanism having a contoured surface, FIG. 7 is a perspective view of cover 710, which may be similar to cover 610 (e.g., having a first portion 712a, a second portion 712b, and a third portion 712c, connected via unlabeled articulating portions, similar to as is described above). FIG. 7 shows a contoured raised portion 736, which corresponds to a substantially rectangular form having rounded corners and may thus correspond to a print device with a base portion having a substantially rectangular form having rounded corners. A lower inner portion 738 may enable reception of a print device, such as print device 602, within the form defined by the combination of lower inner portion 738 and raised portion 736. Also, and similar to the example of FIG. 3, third portion 712c also includes indentations 728a-728d, such as to receive feet of the print device. The contours and indentions may be formed using a molded substrate.

It is to be understood that the foregoing example attachment mechanisms are presented only by way of illustration.

As discussed above, printer covers may also function to receive print media, such as from a media egress. There may be a desire, therefore, for a component to restrict movement of print media, such as to restrain print media from sliding and/or falling off an edge of the printer cover. FIGS. 8A, 8B, 9, 10A, and 10B discuss different example implementations of media stops, which may be capable retaining print, media upon a multi-functional portion of the printer cover.

FIGS. 8A and 8B illustrate an example implementation of media stop 820. In FIG. 8A, media stop 820 is in an operational state (842a), extended, such as to keep media from sliding off an edge of cover 810. This implementation of media stop 820 comprises a folding mechanism including an articulation 844, a magnetic connector 846 and a magnetically reactive component 848, which may be positioned at corresponding locations (the positions of which may be varied without departing from the scope of the description). Media stop 820 may be connected to an edge (or like) of cover 810. Media stop 820 may be connected to a first solid portion of cover 810 (such as first solid portion 212a discussed in relation to FIG. 2),

In operation, therefore, media stop 820 may be unfolded to a first position 842a. And after completion of printing, media stop 820 may be folded upon itself at articulation 844, and held in place by magnetic connector 846 and magnetically reactive component 848.

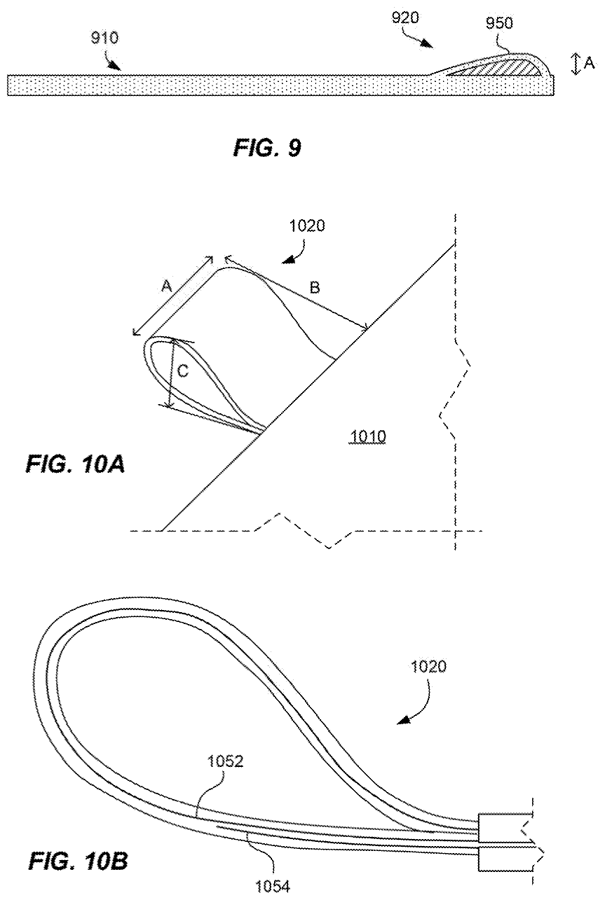

FIG. 9 is a cross-sectional view of yet another example implementation of a cover, this time example cover 910, of which only a portion (e.g., a first portion of cover 910, which may be similar to first solid portion 212a) is shown having a raised molded substrate to define a raised portion 950 at an extremity of cover 910. Raised portion 950 may form an example media stop 920, such as media stop 820 described above. In some examples, media raised portion 950 may be raised approximately 15 mm above a top surface of cover 910. Of course, in other examples, raised more 950 may be raised more or less than 15 mm.

FIGS. 10A and 13B illustrate another example media stop 1020. This example media stop 1020 may comprise a loop (e.g., with loop ends attached to an edge of a rigid portion of cover 1010) and may have materials to cause a top surface to be a distance C from a top surface of cover 1010. In one case, C may comprise approximately 15 mm. Other example measurements are provided merely by way of example. For instance, distance A may comprise approximately 30 mm and B may comprise approximately 30 to 35 mm.

Turning to FIG. 10B, a cross-sectional view is offered to illustrate sample materials of media stop 1020, In one case, media stop 1020 may include an inner semi-rigid sheet 1052, which may comprise 0.175 mm PC sheet. Media stop 1020 may also include a shortening stub 1054 which may comprise a 0.5 mm PC sheet, and may provide a desired form for media stop 1020, such as by maintaining the loop in an open position. As should be appreciated, the additional, thickness of shortening stub 1054 may cause the loop of media stop 1020 to remain open.

It is noted that the foregoing description uses terms such as first, second, and third. However, these terms are merely provided to facilitate the description and are not to be taken in a limiting sense. For instance, a particular claim may use a different numbering scheme without departing from the description.

What is claimed is:

1. A print device comprising:
a plurality of outer surfaces,
a media egress arranged in an outer surface of the plurality of outer surfaces; and
a cover moveable between a first state and a second state, wherein in the second state the cover to obscure the outer surface in which the media egress is arranged.

2. The print device of claim 1, wherein in the first state, the cover is arranged with respect to the media egress to receive print media from the print device.

3. The print device of claim 2, wherein the cover comprises a media stop.

4. The print device of claim 1, wherein the print device comprises a reception mechanism and the cover comprises an attachment mechanism to interact with the reception mechanism.

5. The print device of claim 4, wherein the attachment mechanism comprises a plurality of sliding and latching attachment mechanisms and the reception mechanism comprises a plurality of receptacles to interact with the plurality of sliding and latching attachment mechanisms.

6. A detachable print device accessory comprising:
a molded substrate;
a covering material arranged to cover the molded substrate;
an attachment portion to receive a print device, the attachment portion defined by a portion of the molded substrate and a portion of the covering material; and
a multi-functional portion to transition between a first state and a second state, wherein the second state is to obscure an outer surface of the print device in which a media egress is arranged,

7. The detachable print device accessory of claim 6, wherein the portion of the molded substrate defining the attachment portion comprises a raised portion defining a lower inner portion such that the raised portion and the lower inner portion define a contour of a print device.

8. The detachable print device accessory of claim 6, wherein the multi-functional portion is connected to the attachment portion by an articulating portion.

9. The detachable print device accessory of claim 8, wherein the multi-functional portion comprises two solid portions, wherein one of the two solid portions is to obscure an additional outer surface of the print device in which a media ingress is arranged.

10. A detachable printer cover, comprising:
a plurality of solid portions connected by a plurality of articulating portions;
a first solid portion of the plurality of solid portions defining an attachment portion to receive a print device; and
a second solid portion of the plurality of solid portions and a third solid portion of the plurality of solid portions collectively defining a multi-functional portion to transition between a first state and a second state, wherein the second state is to obscure a first outer surface in which a media egress is arranged and a second outer surface of the print device in which a media ingress is arranged.

11. The detachable printer cover of claim 10, wherein the attachment portion comprises a plurality of magnets arranged in proximity to corners of the attachment portion, the plurality of magnets to correspond to a plurality of magnetically reactive components arranged in a base of the print device.

12. The detachable printer cover of claim 10, wherein the first and the second solid portions of the multi-functional portion are to be arranged with respect to the media egress such that print media leaving the media egress is to be received by the first and the second solid portions while in the first state.

13. The detachable printer cover of claim 10, wherein the plurality of solid portions comprise a molded plastic substrate covered by a fabric material.

14. The detachable printer cover of claim 13, wherein the plurality of articulating portions comprise fabric material articulations between molded plastic substrate of the plurality of solid portions.

15. The detachable printer cover of claim 11 further comprising a media stop coupled to the third solid portion and arranged with respect to the first, the second, and the third solid portions to retain print media on the second and the third solid portions.
